(19) United States
(12) Patent Application Publication
(10) Pub. No.: US 2025/0163202 A1
(43) Pub. Date: May 22, 2025

(54) POLYURETHANE-BASED MIDSOLE COMPOSITION AND SHOE MIDSOLE MADE THEREFROM

(71) Applicant: LEGO STONE CO., LTD., Taichung City (TW)

(72) Inventor: Chung-Hao CHANG, Taichung City (TW)

(21) Appl. No.: 18/735,663

(22) Filed: Jun. 6, 2024

(30) Foreign Application Priority Data
Nov. 16, 2023 (TW) 112144320

(51) Int. Cl. C08G 18/10; C08G 18/22; C08G 18/48

(52) U.S. Cl. CPC C08G 18/10; C08G 18/222; C08G 18/4804

(57) ABSTRACT

A polyurethane-based midsole composition includes a primary component, a catalyst component, and a hardener component. The primary component includes a first polymer polyol, a first chain extender, a second chain extender, water, and a foaming agent. The catalyst component is selected from the group consisting of at least two of a tin-based catalyst, a potassium-based catalyst, a silver-based catalyst, a titanium-based catalyst, a zinc-based catalyst, and a tertiary amine-based catalyst. The hardener component includes a first aliphatic diisocyanate monomer, an aliphatic diisocyanate polymer, and a polyurethane prepolymer. A shoe midsole made from the polyurethane-based midsole composition is also provided.

### CROSS-REFERENCE TO RELATED APPLICATION

This application claims priority to Taiwanese Invention patent application No. 112144320, filed on Nov. 16, 2023, the entire disclosure of which is incorporated by reference herein.

### FIELD

The present disclosure relates to a polymer composition and a footwear component, and more particularly to a polyurethane-based midsole composition and a shoe midsole made therefrom.

### BACKGROUND

At present, shoe midsoles are typically prepared using a polyurethane-based midsole composition which includes a primary component, a catalyst component, and a hardener component. In particular, the primary component includes a polymer polyol, water, and a foaming agent, while the hardener component is an aliphatic diisocyanate monomer and is intended to impart a resistance to yellowing property. However, the shoe midsoles made from the aforesaid polyurethane-based midsole composition gradually yellow with use over time, and thus existing polyurethane-based midsole compositions fail to address the issue of shoe midsole yellowing. In addition, the aforesaid polyurethane-based midsole composition fails to meet a current demand from downstream manufacturers for providing shoe midsoles with a density of not more than 0.4 g/cm³. However, adjusting the amount of each component in the polyurethane-based midsole composition to prepare shoe midsoles with a density of not more than 0.4 g/cm³ may compromise the hardness of the shoe midsoles, such that the hardness of the shoe midsoles will be less than 20 Shore C, which fails to meet current industry standards for the hardness of the shoe midsoles, and may even cause a foam structure formed by the polyurethane-based midsole composition to become coarse to the point that the foam structure cannot be molded to obtain the shoe midsoles.

In view of the aforesaid, there is still a need to develop a polyurethane-based midsole composition that can be used to prepare a shoe midsole with an excellent resistance to yellowing, low density, and suitable hardness, so as to meet industrial requirements.

### SUMMARY

Therefore, an object of the present disclosure is to provide a polyurethane-based midsole composition and a shoe midsole made therefrom, which can alleviate at least one of the drawbacks of the prior art.

According to one aspect of the present disclosure, the polyurethane-based midsole composition includes a primary component, a catalyst component, and a hardener component. The primary component includes a first polymer polyol, a first chain extender, a second chain extender, water, and a foaming agent. The first polymer polyol has an average molecular weight ranging from 100 g/mole to 10000 g/mole. The first chain extender is selected from the group consisting of ethylene glycol, diethylene glycol, and triethylene glycol. The second chain extender is a polyol other than the first chain extender. The first chain extender is present in an amount ranging from 0.25 parts by weight to 30.00 parts by weight, the second chain extender is present in an amount ranging from 0.25 parts by weight to 30.00 parts by weight, the water is present in an amount ranging from 0.10 parts by weight to 20.00 parts by weight, and the foaming agent is present in an amount ranging from 0.10 parts by weight to 15.00 parts by weight, based on 100 parts by weight of the first polymer polyol. The catalyst component is selected from the group consisting of at least two of a tin-based catalyst, a potassium-based catalyst, a silver-based catalyst, a titanium-based catalyst, a zinc-based catalyst, and a tertiary amine-based catalyst. The hardener component includes a first aliphatic diisocyanate monomer, an aliphatic diisocyanate polymer, and a polyurethane prepolymer. The first aliphatic diisocyanate monomer is selected from the group consisting of hexamethylene diisocyanate (HDI), 4,4′-diisocyanato dicyclohexylmethane (H₁₂MDI), isophorone diisocyanate (IPDI), and combinations thereof. The aliphatic diisocyanate polymer has an average molecular weight ranging from 100 g/mole to 10000 g/mole, and is selected from the group consisting of poly(hexamethylene diisocyanate), poly(isophorone diisocyanate), and a combination thereof. The polyurethane prepolymer is prepared by subjecting a second aliphatic diisocyanate monomer and a second polymer polyol to a polymerization reaction. The second aliphatic diisocyanate monomer is selected from the group consisting of hexamethylene diisocyanate (HDI), 4,4′-diisocyanato dicyclohexylmethane (H₁₂MDI), isophorone diisocyanate (IPDI), and combinations thereof. The second polymer polyol has an average molecular weight ranging from 100 g/mole to 10000 g/mole. The catalyst component is present in an amount ranging from 0.5 parts by weight to 30.0 parts by weight, based on a total amount of the primary component as 100 parts by weight. The hardener component is present in an amount ranging from 20 parts by weight to 300 parts by weight, based on a total amount of the primary component and the catalyst component as 100 parts by weight.

According to another aspect of the present disclosure, the shoe midsole is prepared by subjecting the aforesaid polyurethane-based midsole composition to a polymerization reaction, followed by conducting a foaming process and a molding process in sequence.

### DETAILED DESCRIPTION

For the purpose of this specification, it will be clearly understood that the word “comprising” means “including but not limited to”, and that the word “comprises” has a corresponding meaning.

It is to be understood that, if any prior art publication is referred to herein, such reference does not constitute an admission that the publication forms a part of the common general knowledge in the art, in Taiwan or any other country.

Unless defined otherwise, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides a polyurethane-based midsole composition including a primary component, a catalyst component, and a hardener component. In a preparation of a shoe midsole with an excellent resistance to yellowing from the polyurethane-based midsole composition, the primary component, the catalyst component, and the hardener component are mixed, followed by conducting a polymerization reaction, a foaming process, and a molding process in sequence, so as to obtain the shoe midsole with an excellent resistance to yellowing.

According to the present disclosure, the primary component includes a first polymer polyol, a first chain extender, a second chain extender, water, and a foaming agent.

According to the present disclosure, the first polymer polyol serves as a main ingredient of the shoe midsole, and is subjected to a polymerization reaction with the hardener component. The first polymer polyol has an average molecular weight ranging from 100 g/mole to 10000 g/mole. By virtue of controlling the average molecular weight of the first polymer polyol to be not less than 100 g/mole, a foam structure, which is formed by subjecting the polyurethane-based midsole composition to the foaming process, can be prevented from becoming coarse, so that the polyurethane-based midsole composition can be molded after the foaming process to obtain the shoe midsole which has a density of not more than 0.4 g/cm³ and a hardness of not less than 20 Shore C. In addition, by virtue of controlling the average molecular weight of the first polymer polyol to be not more than 10000 g/mole, the primary component is provided with an excellent fluidity, so that the polyurethane-based midsole composition can be used in mass production of the shoe midsole. Types of the first polymer polyol are not particularly limited, as long as the first polymer polyol of such types can be subjected to a polymerization reaction with the hardener component so as to prepare the shoe midsole. In certain embodiments, the first polymer polyol is selected from the group consisting of polytetrahydrofuran, polyether polyol, polyester polyol, polycaprolactone polyol, and polycarbonate polyol. In certain embodiments, the first polymer polyol may be a synthetic polymer polyol or a polymer polyol derived from biomass raw materials. Examples of the polymer polyol derived from biomass raw materials may include, but are not limited to, soybean oil, corn oil, and palm oil.

According to the present disclosure, the first chain extender is primarily used in combination with the second chain extender such that the shoe midsole has a low density ranging from 0.2 g/cm³ to 0.4 g/cm³ without a change in a volume of the shoe midsole, permitting the shoe midsole to have a lightweight property, and such that the shoe midsole has a hardness ranging from 20 Shore C to 70 Shore C. The first chain extender is selected from the group consisting of ethylene glycol, diethylene glycol, and triethylene glycol.

According to the present disclosure, the second chain extender is primarily used in combination with the first chain extender such that the shoe midsole has a low density ranging from 0.2 g/cm³ to 0.4 g/cm³ without a change in a volume of the shoe midsole, permitting the shoe midsole to have a lightweight property, and such that the shoe midsole has a hardness ranging from 20 Shore C to 70 Shore C. The second chain extender is a polyol other than the first chain extender. In certain embodiments, the second chain extender is selected from the group consisting of 2-methyl-1,3-propanediol, pentaerythritol, and dipentaerythritol.

In certain embodiments, the foaming agent is mainly used such that the shoe midsole with uniform foaming pores and dense foaming structure is formed after the polyurethane-based midsole composition is subjected to the foaming process. Types of the foaming agent are not particularly limited, as long as the forming agent of such types permit the shoe midsole with the uniform foaming pores and dense foaming structure to be formed after the polyurethane-based midsole composition is subjected to the foaming process.

According to the present disclosure, in the primary component, the first chain extender is present in an amount ranging from 0.25 parts by weight to 30.00 parts by weight, the second chain extender is present in an amount ranging from 0.25 parts by weight to 30.00 parts by weight, the water is present in an amount ranging from 0.10 parts by weight to 20.00 parts by weight, and the foaming agent is present in an amount ranging from 0.10 parts by weight to 15.00 parts by weight, based on 100 parts by weight of the first polymer polyol. According to the present disclosure, by virtue of the amount of the first chain extender being not less than 0.25 parts by weight, the shoe midsole can have the uniform foaming pores and dense foaming structure, while by virtue of the amount of the first chain extender being not more than 30.00 parts by weight, a problem of a shoe midsole collapsing after the molding process can be prevented. By virtue of the amount of the second chain extender being not less than 0.25 parts by weight, the shoe midsole can have the hardness of not less than 20 Shore C, and after continuous exposure to ultraviolet light for 96 hours, the shoe midsole will not show signs of aging such as chalking, while by virtue of the amount of the second chain extender being not more than 30.00 parts by weight, the problem of the shoe midsole collapsing after the molding process can be prevented. By virtue of the amount of the water being not less than 0.10 parts by weight, the shoe midsole can have the density of not more than 0.4 g/cm³, while by virtue of the amount of the water being not more than 20.00 parts by weight, the shoe midsole can have the density of not less than 0.2 g/cm³. By virtue of the amount of the foaming agent being not less than 0.10 parts by weight, the shoe midsole can have the uniform foaming pores and dense foaming structure, while by virtue of the amount of the foaming agent being not more than 15.00 parts by weight, the problem of the shoe midsole collapsing after the molding process can be prevented.

In certain embodiments, in order to further adjust a reactivity of the polymerization reaction between the primary component and the hardener component, or to further adjust properties of the shoe midsole, the primary component may further include an additive ingredient. The additive ingredient is selected from the group consisting of an ultraviolet (UV) absorber, a light stabilizer, an antioxidant, a coolant, a colorant, and combinations thereof. In certain embodiments, when the primary component further includes any one of the UV absorber, the light stabilizer, the antioxidant, the coolant, or combinations thereof, the UV absorber, the light stabilizer, the antioxidant, or the coolant is present in an amount ranging from 0.1 parts by weight to 15.0 parts by weight, based on 100 parts by weight of the first polymer polyol. By virtue of the amount of the UV absorber, the light stabilizer, the antioxidant, or the coolant being not less than 0.1 parts by weight, the UV absorber, the light stabilizer, the antioxidant, or the coolant can exert functions thereof. By virtue of the amount of the UV absorber, the light stabilizer, the antioxidant, or the coolant being not more than 15.0 parts by weight, the polyurethane-based midsole composition is able to be smoothly molded after the foaming process so as to obtain the shoe midsole. In certain embodiments, when the primary component further includes the colorant, the colorant is present in an amount ranging from 0.001 parts by weight to 10.000 parts by weight, based on 100 parts by weight of the first polymer polyol. By virtue of the amount of the colorant being not less than 0.001 parts by weight, the colorant can exert functions thereof, while by virtue of the amount of the colorant being not more than 10.000 parts by weight, a color of the shoe midsole is white.

According to the present disclosure, the catalyst component is provided to facilitate the polymerization reaction between the primary component and the hardener component, so that the polyurethane-based midsole composition can be formed into the shoe midsole. The catalyst component is selected from the group consisting of at least two of a tin-based catalyst, a potassium-based catalyst, a silver-based catalyst, a titanium-based catalyst, a zinc-based catalyst, and a tertiary amine-based catalyst. In certain embodiments, the catalyst component includes the titanium-based catalyst and the potassium-based catalyst.

According to the present disclosure, the polyurethane-based midsole composition can be formed into the shoe midsole by subjecting the hardener component to a polymerization reaction with the primary component. The hardener component includes a first aliphatic diisocyanate monomer, an aliphatic diisocyanate polymer, and a polyurethane prepolymer.

As used herein, the term “aliphatic diisocyanate monomer” refers to a compound containing two isocyanate groups. The term “aliphatic diisocyanate polymer” refers to a compound containing not less than three isocyanate groups.

According to the present disclosure, the first aliphatic diisocyanate monomer provides the shoe midsole made from the polyurethane-based midsole composition with an excellent resistance to yellowing. The first aliphatic diisocyanate monomer is selected from the group consisting of hexamethylene diisocyanate (HDI), 4,4′-diisocyanato dicyclohexylmethane (H₁₂MDI), isophorone diisocyanate (IPDI), and combinations thereof. In certain embodiments, the first aliphatic diisocyanate monomer includes HDI and IPDI. In certain embodiments, the first aliphatic diisocyanate monomer is present in an amount ranging from 1 part by weight to 75 parts by weight, based on a total amount of the hardener component as 100 parts by weight. In an exemplary embodiment, the first aliphatic diisocyanate monomer is present in an amount ranging from 37.5 parts by weight to 50 parts by weight, based on a total amount of the hardener component as 100 parts by weight.

When the aliphatic diisocyanate polymer combines with the first aliphatic diisocyanate monomer, the foaming process and the molding process, conducted in sequence, of the polyurethane-based midsole composition are facilitated so as to obtain the shoe midsole. The shoe midsole thus obtained does not suffer from collapsing issues after the molding process, and the aliphatic diisocyanate polymer provides the shoe midsole with an excellent resistance to yellowing as well. Furthermore, the aliphatic diisocyanate polymer provides the shoe midsole with a low density ranging from 0.2 g/cm³ to 0.4 g/cm³ so that the shoe midsole has a lightweight property without a change in a volume of the shoe midsole, and with a hardness ranging from 20 Shore C to 70 Shore C. The aliphatic diisocyanate polymer has an average molecular weight ranging from 100 g/mole to 10000 g/mole, and is selected from the group consisting of poly(hexamethylene diisocyanate), poly(isophorone diisocyanate), and a combination thereof. In certain embodiments, the poly(hexamethylene diisocyanate) is hexamethylene diisocyanate dimer (HDI dimer). In certain embodiments, the poly(isophorone diisocyanate) is isophorone diisocyanate dimer (IPDI dimer). Examples of the IPDI dimer may include, but are not limited to, uretdione dimer of isophorone diisocyanate (uretdione dimer of IPDI). According to the present disclosure, by virtue of controlling the average molecular weight of the aliphatic diisocyanate polymer to be not less than 100 g/mole, the hardener component is able to undergo polymerization reaction with the primary component, thereby facilitating the subsequent foaming process. By virtue of controlling the average molecular weight of the aliphatic diisocyanate polymer to be not more than 10000 g/mole, the hardener component is provided with an excellent fluidity, so that the polyurethane-based midsole composition can be used in mass production of the shoe midsole. In certain embodiments, in order to enhance a reactivity of the hardener component such that the polyurethane-based midsole composition can undergo the polymerization reaction and then the foaming process, the aliphatic diisocyanate polymer has an average molecular weight ranging from 100 g/mole to 3000 g/mole.

In certain embodiments, the aliphatic diisocyanate polymer is present in an amount ranging from 1 part by weight to 75 parts by weight, based on a total amount of the hardener component as 100 parts by weight. In an exemplary embodiment, in order to further enhance a reactivity between the hardener component, and the first chain extender and the second chain extender of the primary component, thus permitting the shoe midsole to have a hardness ranging from 20 Shore C to 70 Shore C and a density ranging from 0.2 g/cm³ to 0.4 g/cm³, the aliphatic diisocyanate polymer is present in an amount ranging from 25 parts by weight to 50 parts by weight, based on a total amount of the hardener component as 100 parts by weight.

According to the present disclosure, the polyurethane prepolymer is provided to facilitate the polymerization reaction between the primary component and the hardener component, so that the polyurethane-based midsole composition can be formed into the shoe midsole. The polyurethane prepolymer is prepared by subjecting a second aliphatic diisocyanate monomer and a second polymer polyol to a polymerization reaction. The second aliphatic diisocyanate monomer is selected from the group consisting of hexamethylene diisocyanate (HDI), 4,4′-diisocyanato dicyclohexylmethane (H₁₂MDI), isophorone diisocyanate (IPDI), and combinations thereof. The second polymer polyol has an average molecular weight ranging from 100 g/mole to 10000 g/mole. Types of the second polymer polyol are not particularly limited, as long as the second polymer polyol such types thereof can be subjected to a polymerization reaction with the second aliphatic diisocyanate monomer so as to prepare the polyurethane prepolymer. In certain embodiments, the second polymer polyol is selected from the group consisting of polytetrahydrofuran, polyether polyol, polyester polyol, polycaprolactone polyol, and polycarbonate polyol. In certain embodiments, the polyurethane prepolymer is present in an amount ranging from 1 part by weight to 75 parts by weight, based on a total amount of the hardener component as 100 parts by weight. In an exemplary embodiment, the polyurethane prepolymer is present in an amount ranging from 12.5 parts by weight to 30 parts by weight, based on a total amount of the hardener component as 100 parts by weight.

In certain embodiments, in order to further accelerate a reaction rate of the polymerization reaction between the primary component and the hardener component, the hardener component further includes an aromatic diisocyanate polymer. The aromatic diisocyanate polymer is selected from the group consisting of poly(m-xylylene diisocyanate) (abbreviated as polymeric XDI) and poly(hydrogenated m-xylylene diisocyanate) (abbreviated as polymeric H₆XDI). In addition to an ability of the aromatic diisocyanate polymer to accelerate the reaction rate of the polymerization reaction between the primary component and the hardener component, the aromatic diisocyanate polymer is able to provide the shoe midsole with an excellent resistance to yellowing. In certain embodiments, the aromatic diisocyanate polymer is present in an amount ranging from 1 part by weight to 75 parts by weight, based on a total amount of the hardener component as 100 parts by weight. By virtue of the amount of the aromatic diisocyanate polymer being not less than 1 part by weight, the aromatic diisocyanate polymer is reactive. By virtue of the amount of the aromatic diisocyanate polymer being not more than 75 parts by weight, the problem of the shoe midsole collapsing after the molding process can be prevented. In other embodiments, in order to further provide the shoe midsole with suitable toughness and tear strength, the aromatic diisocyanate polymer is present in an amount ranging from 1 part by weight to 15 parts by weight, based on a total amount of the hardener component as 100 parts by weight. In an exemplary embodiment, in order to further adjust the toughness and tear strength of the shoe midsole, the aromatic diisocyanate polymer is present in an amount ranging from 5 parts by weight to 15 parts by weight, based on a total amount of the hardener component as 100 parts by weight.

According to the present disclosure, in the polyurethane-based midsole composition, the catalyst component is present in an amount ranging from 0.5 parts by weight to 30.0 parts by weight, based on a total amount of the primary component as 100 parts by weight. The hardener component is present in an amount ranging from 20 parts by weight to 300 parts by weight, based on a total amount of the primary component and the catalyst component as 100 parts by weight. According to the present disclosure, by virtue of the amount of the catalyst component being not less than 0.5 parts by weight, the polyurethane-based midsole composition can be subjected to the polymerization reaction, the foaming process, and the molding process in sequence so as to obtain the shoe midsole, while by virtue of the amount of the catalyst component being not more than 30.0 parts by weight, the problem of the shoe midsole collapsing after the molding process can be prevented. By virtue of the amount of the hardener component being not less than 20 parts by weight, the polyurethane-based midsole composition can be subjected to the polymerization reaction, while by virtue of the amount of the hardener component being not more than 300 parts by weight, the problem of the shoe midsole collapsing after the molding process can be prevented.

The present disclosure also provides a shoe midsole which is prepared by subjecting the polyurethane-based midsole composition of any of the aforesaid embodiments of the disclosure to the polymerization reaction, followed by conducting the foaming process and the molding process in sequence.

According to the present disclosure, the shoe midsole has a density ranging from 0.2 g/cm³ to 0.4 g/cm³.

According to the present disclosure, the shoe midsole has a hardness ranging from 20 Shore C to 70 Shore C.

According to the present disclosure, by virtue of the materials (particularly the first chain extender and the second chain extender) and the amounts thereof for making the primary component, the aliphatic diisocyanate polymer being present in a specific amount in the hardener component, and adjusting the amounts of the primary component, the catalyst component, and the hardener component, the shoe midsole made therefrom can have a low density ranging from 0.2 g/cm³ to 0.4 g/cm³ and a hardness ranging from 20 Shore C to 70 Shore C. In addition, by virtue of the materials and the amounts of the hardener component in the polyurethane-based midsole composition as described above, the shoe midsole made from the polyurethane-based midsole composition can exhibit an excellent resistance to yellowing.

The disclosure will be further described by way of the following examples. However, it should be understood that the following examples are solely intended for the purpose of illustration and should not be construed as limiting the disclosure in practice.

### EXAMPLES

### Example 1 (EX1)

The materials and the amounts thereof for preparing the polyurethane-based midsole composition of EX1 are shown in Table 1 below. First, 100 parts by weight of polyether polyol (serving as a first polymer polyol, Manufacturer: Shell Chemicals, Model no.: CARADOL MC28-02, Average molecular weight: 6000 g/mole), 6 parts by weight of diethylene glycol (serving as a first chain extender), 10 parts by weight of 2-methyl-1,3-propanediol (serving as a second chain extender), 2 parts by weight of water, 2 parts by weight of an ultraviolet (UV) absorber (Manufacturer: BASF, Trade name: Tinuvin® 213), 1 part by weight of a light stabilizer (Manufacturer: BASF, Trade name: Tinuvin® 765), 1 part by weight of an antioxidant (Manufacturer: BASF, Trade name: Irganox® 1135), 2 parts by weight of dihydrate gypsum (serving as a coolant), 2 parts by weight of a foaming agent (Manufacturer: Momentive Performance Materials, Inc., Model no.: L-580), and 0.1 parts by weight of a colorant (Manufacturer: Milliken, Model no.: Reactint Blue X3LV) were mixed together, so as to obtain a primary component with a total amount of 126.1 parts by weight.

In addition, 5 parts by weight of (2-propanolato)-[(2,2′,2″-nitrilotris[ethanolato])-(3)-N,O,O′,O″]titanium (serving as a titanium-based catalyst, Manufacturer: DuPont, Trade name: TYZOR® TE, CAS no.: 14483-21-7) and 8 parts by weight of potassium 2-ethylhexanoate (serving as a potassium-based catalyst) were mixed together, so as to obtain a catalyst component which was present in an amount of 13 parts by weight, based on a total amount of the primary component as 100 parts by weight.

Furthermore, 30 parts by weight of hexamethylene diisocyanate (abbreviated as HDI, serving as a first aliphatic diisocyanate monomer), 15 parts by weight of isophorone diisocyanate (abbreviated as IPDI, serving as a first aliphatic diisocyanate monomer), 15 parts by weight of hexamethylene diisocyanate dimer (abbreviated as HDI dimer, serving as an aliphatic diisocyanate polymer), 10 parts by weight of uretdione dimer of isophorone diisocyanate (abbreviated as uretdione dimer of IPDI, serving as an aliphatic diisocyanate polymer), and 30 parts by weight of a polyurethane prepolymer were mixed together, so as to obtain a hardener component which was present in an amount of 100 parts by weight, based on a total amount of the primary component and the catalyst component as 100 parts by weight. The polyurethane prepolymer was prepared by subjecting 50 parts by weight of polyether polyol (serving as a second polymer polyol, Manufacturer: Shell Chemicals, Model no.: CARADOL MC28-02, Average molecular weight: 6000 g/mole) and 50 parts by weight of 4,4′-diisocyanato dicyclohexylmethane (abbreviated as H₁₂MDI, serving as a second aliphatic diisocyanate monomer) to a polymerization reaction.

Next, the primary component and the catalyst component were mixed and uniformly stirred, followed by adding into a polyol raw material drum of a two-component mixing system (Manufacturer: Wason Technology Co. Ltd, Model no.: G-380), and adding the hardener component into an ISO raw material drum of the two-component mixing system. Thereafter, the primary component, the catalyst component, and the hardener component were mixed using a mixing head of the two-component mixing system, so as to obtain the polyurethane-based midsole composition of EX1. Subsequently, the polyurethane-based midsole composition of EX1 was injected into an aluminum mold for shoe midsoles at a controlled temperature ranging from 25° C. to 50° C., followed by subjecting the polyurethane-based midsole composition of EX1 to a polymerization reaction and a foaming process in sequence, and then waiting for the thus foamed polyurethane-based midsole composition of EX1 to be molded, so as to obtain a shoe midsole of EX1.

### Examples 2 to 9 (EX2 to EX9)

The materials and the amounts thereof for making the polyurethane-based midsole compositions of EX2 to EX9 and the procedures for preparing the shoe midsoles of EX2 to EX9 were similar to those of EX1, except that the amounts of the first chain extender and the second chain extender for the respective one of the polyurethane-based midsole compositions of EX2 and EX3, the amounts of the titanium-based catalyst and the potassium-based catalyst for the respective one of the polyurethane-based midsole compositions of EX4 and EX5, and the materials and the amounts thereof for making the hardener component for the respective one of the polyurethane-based midsole compositions of EX6 to EX9 were varied as shown in Table 1 and Table 2 below. To be specific, the hardener component for the respective one of EX8 and EX9 further included an aromatic diisocyanate polymer, such as poly(m-xylylene diisocyanate) (abbreviated as polymeric XDI) and poly(hydrogenated m-xylylene diisocyanate) (abbreviated as polymeric H₆XDI), respectively.

### Comparative Example 1 (CE1)

The materials and the amounts thereof for making the polyurethane-based midsole composition of CE1 and the procedures for preparing the shoe midsole of CE1 were similar to those of EX1, except that the primary component of CE1 did not include the first chain extender and the second chain extender, as shown in Table 2 below.

### Comparative Example 2 (CE2)

The materials and the amounts thereof for making the polyurethane-based midsole composition of CE2 and the procedures for preparing the shoe midsole of CE2 were similar to those of EX1, except that the hardener component of CE2 did not include the aliphatic diisocyanate polymer, as shown in Table 2 below.

TABLE 1

| | | | EX1 | EX2 | EX3 | EX4 | EX5 |
|---|---|---|---|---|---|---|---|
| | | | Unit: part(s) by weight | | | | |
| Primary | First polymer polyol | | 100 | 100 | 100 | 100 | 100 |
| component | (Polyether polyol) | | | | | | |
| | First chain extender | | 6 | 0.25 | 30 | 6 | 6 |
| | (Diethylene glycol) | | | | | | |
| | Second chain extender | | 10 | 0.25 | 30 | 10 | 10 |
| | (2-methyl-1,3-propanediol) | | | | | | |
| | Water | | 2 | 2 | 2 | 2 | 2 |
| | UV absorber | | 2 | 2 | 2 | 2 | 2 |
| | (Tinuvin ® 213) | | | | | | |
| | Light stabilizer | | 1 | 1 | 1 | 1 | 1 |
| | (Tinuvin ® 765) | | | | | | |
| | Antioxidant | | 1 | 1 | 1 | 1 | 1 |
| | (Irganox ® 1135) | | | | | | |
| | Coolant | | 2 | 2 | 2 | 2 | 2 |
| | (Dihydrate gypsum) | | | | | | |
| | Foaming agent | | 2 | 2 | 2 | 2 | 2 |
| | (Momentive L-580) | | | | | | |
| | Colorant | | 0.1 | 0.1 | 0.1 | 0.1 | 0.1 |
| | (Milliken Reactint Blue | | | | | | |
| | X3LV) | | | | | | |
| | Total amount of primary | | 126.1 | 110.6 | 170.1 | 126.1 | 126.1 |
| | component | | | | | | |
| Catalyst | Titanium-based catalyst | | 5 | 5 | 5 | 0.25 | 15 |
| component | (TYZOR ® TE) | | | | | | |
| | Potassium-based catalyst | | 8 | 8 | 8 | 0.25 | 15 |
| | (Potassium 2- | | | | | | |
| | ethylhexanoate) | | | | | | |
| | Total amount of catalyst | | 13 | 13 | 13 | 0.5 | 30 |
| | component | | | | | | |
| Hardener | First | HDI | 30 | 30 | 30 | 30 | 30 |
| component | aliphatic | IPDI | 15 | 15 | 15 | 15 | 15 |
| | diisocyanate | | | | | | |
| | monomer | | | | | | |
| | Aliphatic | HDI dimer | 15 | 15 | 15 | 15 | 15 |
| | diisocyanate | Uretdione | 10 | 10 | 10 | 10 | 10 |
| | polymer | dimer of | | | | | |
| | | IPDI | | | | | |

| | | | | | |
|---|---|---|---|---|---|
| Polyurethane prepolymer | 30 | 30 | 30 | 30 | 30 |
| Total amount of hardener | 100 | 100 | 100 | 100 | 100 |
| component | | | | | |

TABLE 2

| | | | EX6 | EX7 | EX8 | EX9 | CE1 | CE2 |
|---|---|---|---|---|---|---|---|---|
| | | | Unit: part(s) by weight | | | | | |
| Primary | First polymer polyol | | 100 | 100 | 100 | 100 | 100 | 100 |
| component | (Polyether polyol) | | | | | | | |
| | First chain extender | | 6 | 6 | 6 | 6 | 0 | 6 |
| | (Diethylene glycol) | | | | | | | |
| | Second chain extender | | 10 | 10 | 10 | 10 | 0 | 10 |
| | (2-methyl-1,3-propanediol) | | | | | | | |
| | Water | | 2 | 2 | 2 | 2 | 2 | 2 |
| | UV absorber | | 2 | 2 | 2 | 2 | 2 | 2 |
| | (Tinuvin ® 213) | | | | | | | |
| | Light stabilizer | | 1 | 1 | 1 | 1 | 1 | 1 |
| | (Tinuvin ® 765) | | | | | | | |
| | Antioxidant | | 1 | 1 | 1 | 1 | 1 | 1 |
| | (Irganox ® 1135) | | | | | | | |
| | Coolant | | 2 | 2 | 2 | 2 | 2 | 2 |
| | (Dihydrate gypsum) | | | | | | | |
| | Foaming agent | | 2 | 2 | 2 | 2 | 2 | 2 |
| | (Momentive L-580) | | | | | | | |
| | Colorant | | 0.1 | 0.1 | 0.1 | 0.1 | 0.1 | 0.1 |
| | (Milliken Reactint Blue | | | | | | | |
| | X3LV) | | | | | | | |
| | Total amount of primary | | 126.1 | 126.1 | 126.1 | 126.1 | 110.1 | 126.1 |
| | component | | | | | | | |
| Catalyst | Titanium-based catalyst | | 5 | 5 | 5 | 5 | 5 | 5 |
| component | (TYZOR ® TE) | | | | | | | |
| | Potassium-based catalyst | | 8 | 8 | 8 | 8 | 8 | 8 |
| | (Potassium 2- | | | | | | | |
| | ethylhexanoate) | | | | | | | |
| | Total amount of catalyst | | 13 | 13 | 13 | 13 | 13 | 13 |
| | component | | | | | | | |
| Hardener | First | HDI | 2.5 | 50 | 30 | 30 | 30 | 20 |
| component | aliphatic | IPDI | 5 | 100 | 15 | 15 | 15 | 50 |
| | diisocyanate | | | | | | | |
| | monomer | | | | | | | |
| | Aliphatic | HDI dimer | 5 | 50 | 15 | 15 | 15 | 0 |
| | diisocyanate | Uretdione | 5 | 50 | 0 | 0 | 10 | 0 |
| | polymer | dimer of IPDI | | | | | | |
| | Aromatic | Polymeric | 0 | 0 | 10 | 0 | 0 | 0 |
| | diisocyanate | XDI | | | | | | |
| | polymer | Polymeric | 0 | 0 | 0 | 10 | 0 | 0 |
| | | H₆XDI | | | | | | |

| | | | | | | |
|---|---|---|---|---|---|---|
| Polyurethane prepolymer | 2.5 | 50 | 30 | 30 | 30 | 30 |
| Total amount of hardener | 20 | 300 | 100 | 100 | 100 | 100 |
| component | | | | | | |

### Property Evaluation

### A. Measurement of Hardness

The shoe midsole of the respective one of EX1 to EX9, CE1 and CE2 was subjected to determination of hardness using an ASKER durometer Type C with a ball indenter (Manufacturer: Kobunshi Keiki Co. Ltd, Model no.: ASKER C type). The results are shown in Table 3 below.

### B. Measurement of Density

The shoe midsole of the respective one of EX1 to EX9, CE1 and CE2 was subjected to determination of density using a Multi-Function Density Tester for Solid and Liquid (Manufacturer: MatsuHaku, Model no.: MH-120S) in accordance with the standard method ASTM D792-20 (published in 2020) for density and specific gravity (relative density) of plastics by displacement. The results are shown in Table 3 below.

### C. Measurement of Resistance to Yellowing

The shoe midsole of the respective one of EX1 to EX9, CE1 and CE2 was subjected to determination of resistance to yellowing by continuously exposing the shoe midsole to ultraviolet light using a QUV Accelerated Weathering Tester (Manufacturer: Q-Lab corporation in the USA, Model no.: Lu-0801) in accordance with the standard method ASTM G154-16 (published in 2016) or ASTM D1148 (published in 2018), so as to obtain a QUV rating. The results are shown in Table 4 below.

### Results

TABLE 3

| | Hardness (Shore C) | Density (g/cm³) |
|---|---|---|
| EX1 | 45 | 0.25 |
| EX2 | 35 | 0.35 |
| EX3 | 50 | 0.30 |
| EX4 | 40 | 0.40 |
| EX5 | 25 | 0.22 |
| EX6 | 20 | 0.30 |
| EX7 | 70 | 0.25 |
| EX8 | 45 | 0.25 |
| EX9 | 45 | 0.25 |
| CE1 | 15 | 0.45 |
| CE2 | 15 | 0.45 |

TABLE 4

| | Continuous UV exposure | |
|---|---|---|
| | time (hours) | QUV rating |
| EX1 | 96 | 4.0 to 4.5 |
| EX2 | 96 | 4.0 to 4.5 |
| EX3 | 96 | 4.0 to 4.5 |
| EX4 | 96 | 4.0 to 4.5 |
| EX5 | 96 | 4.0 to 4.5 |
| EX6 | 96 | 4.0 to 4.5 |
| EX7 | 96 | 4.0 to 4.5 |
| EX8 | 96 | 4.0 to 4.5 |
| EX9 | 96 | 4.0 to 4.5 |
| CE1 | 24 | 2.5 to 3.0 |
| CE2 | 24 | 2.5 to 3.0 |

Referring to Tables 1 to 3, in the polyurethane-based midsole composition of each of EX1 to EX9, by virtue of the materials (particularly the first chain extender and the second chain extender) and the amounts thereof for making the primary component, the aliphatic diisocyanate polymer being present in a specific amount in the hardener component, and adjusting the amounts of the primary component, the catalyst component, and the hardener component, the shoe midsole of each of EX1 to EX9 had a density ranging from 0.2 g/cm³ to 0.4 g/cm³ and had a hardness ranging from 20 Shore C to 70 Shore C, thereby permitting the shoe midsole of each of EX1 to EX9 to have an advantage of being lightweight without a change in a volume of the shoe midsole, and ensuring that the shoe midsole of each of EX1 to EX9 meets the current industry standards for the hardness of the shoe midsole.

In contrast, in the polyurethane-based midsole composition of CE1, since the primary component did not include the first chain extender and the second chain extender, the density of the shoe midsole of CE1 reached as high as 0.45 g/cm³ and the hardness of the shoe midsole of CE1 was only 15 Shore C, resulting in the shoe midsole of CE1 having an excessive weight without a change in a volume of the shoe midsole, and failing to meet the current industry standards for the hardness of the shoe midsoles. Moreover, in the polyurethane-based midsole composition of CE2, since the hardener component did not include the aliphatic diisocyanate polymer, the density of the shoe midsole of CE2 reached as high as 0.45 g/cm³ and the hardness of the shoe midsole of CE2 was only 15 Shore C, resulting in the shoe midsole of CE2 having an excessive weight without a change in a volume of the shoe midsole, and failing to meet the current industry standards for the hardness of the shoe midsoles.

On the other hand, in terms of the current industry standards for evaluating resistance to yellowing of shoe midsoles, if a shoe midsole achieves a QUV rating of not less than 3.5 after continuous exposure to ultraviolet light for 24 hours, such shoe midsole has an excellent resistance to yellowing. As shown in Table 4, the shoe midsole of the respective one of EX1 to EX9 achieved a QUV rating ranging from 4.0 to 4.5 after continuous exposure to ultraviolet light for 96 hours, indicating that the shoe midsole of the respective one of EX1 to EX9 had a fairly excellent resistance to yellowing. In contrast, the shoe midsole of the respective one of CE1 and CE2 only achieved a QUV rating ranging from 2.5 to 3.5 after continuous exposure to ultraviolet light for 24 hours, indicating that the shoe midsole of the respective one of CE1 and CE2 had a poor resistance to yellowing.

Summarizing the above test results, it is clear that in the polyurethane-based midsole composition of the present disclosure, by virtue of the materials (particularly the first chain extender and the second chain extender) and the amounts thereof for making the primary component, the aliphatic diisocyanate polymer being present in a specific amount in the hardener component, and adjusting the amounts of the primary component, the catalyst component, and the hardener component, the shoe midsole prepared from the polyurethane-based midsole composition of the present disclosure can have a low density ranging from 0.2 g/cm³ to 0.4 g/cm³ with an advantage of being lightweight without a change in a volume of the shoe midsole, and thus is comparable to shoe midsoles (i.e., EVA shoe midsoles) made form ethylene-vinyl acetate (EVA) materials. In addition, besides providing the shoe midsole with the low density advantage, the polyurethane-based midsole composition of the present disclosure also does not compromise the hardness of the shoe midsole, thereby ensuring that the shoe midsole has a hardness ranging from 20 Shore C to 70 Shore C so as to meet the current industry standards. Furthermore, by virtue of the aforesaid specific materials and the amounts thereof for making the polyurethane-based midsole composition of the present disclosure, the shoe midsole prepared from the polyurethane-based midsole composition of the present disclosure exhibits an excellent resistance to yellowing.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A polyurethane-based midsole composition, comprising:
a primary component which includes
a first polymer polyol having an average molecular weight ranging from 100 g/mole to 10000 g/mole,
a first chain extender selected from the group consisting of ethylene glycol, diethylene glycol, and triethylene glycol,
a second chain extender which is a polyol other than the first chain extender,
water, and
a foaming agent,
wherein the first chain extender is present in an amount ranging from 0.25 parts by weight to 30.00 parts by weight, the second chain extender is present in an amount ranging from 0.25 parts by weight to 30.00 parts by weight, the water is present in an amount ranging from 0.10 parts by weight to 20.00 parts by weight, and the foaming agent is present in an amount ranging from 0.10 parts by weight to 15.00 parts by weight, based on 100 parts by weight of the first polymer polyol;
a catalyst component which is selected from the group consisting of at least two of a tin-based catalyst, a potassium-based catalyst, a silver-based catalyst, a titanium-based catalyst, a zinc-based catalyst, and a tertiary amine-based catalyst; and
a hardener component which includes
a first aliphatic diisocyanate monomer selected from the group consisting of hexamethylene diisocyanate (HDI), 4,4′-diisocyanato dicyclohexylmethane (H₁₂MDI), isophorone diisocyanate (IPDI), and combinations thereof,
an aliphatic diisocyanate polymer having an average molecular weight ranging from 100 g/mole to 10000 g/mole, and selected from the group consisting of poly(hexamethylene diisocyanate), poly(isophorone diisocyanate), and a combination thereof, and
a polyurethane prepolymer prepared by subjecting a second aliphatic diisocyanate monomer and a second polymer polyol to a polymerization reaction, the second aliphatic diisocyanate monomer being selected from the group consisting of hexamethylene diisocyanate (HDI), 4,4′-diisocyanato dicyclohexylmethane (H₁₂MDI), isophorone diisocyanate (IPDI), and combinations thereof, the second polymer polyol having an average molecular weight ranging from 100 g/mole to 10000 g/mole;
wherein the catalyst component is present in an amount ranging from 0.5 parts by weight to 30.0 parts by weight, based on a total amount of the primary component as 100 parts by weight, and the hardener component is present in an amount ranging from 20 parts by weight to 300 parts by weight, based on a total amount of the primary component and the catalyst component as 100 parts by weight.

2. The polyurethane-based midsole composition as claimed in claim 1, wherein the first polymer polyol is selected from the group consisting of polytetrahydrofuran, polyether polyol, polyester polyol, polycaprolactone polyol, and polycarbonate polyol.

3. The polyurethane-based midsole composition as claimed in claim 1, wherein the second chain extender is selected from the group consisting of 2-methyl-1,3-propanediol, pentaerythritol, and dipentaerythritol.

4. The polyurethane-based midsole composition as claimed in claim 1, wherein the second polymer polyol is selected from the group consisting of polytetrahydrofuran, polyether polyol, polyester polyol, polycaprolactone polyol, and polycarbonate polyol.

5. The polyurethane-based midsole composition as claimed in claim 1, wherein the aliphatic diisocyanate polymer is present in an amount ranging from 25 parts by weight to 50 parts by weight, based on a total amount of the hardener component as 100 parts by weight.

6. The polyurethane-based midsole composition as claimed in claim 1, wherein the primary component further includes an additive ingredient, the additive ingredient being selected from the group consisting of an ultraviolet (UV) absorber, a light stabilizer, an antioxidant, a coolant, a colorant, and combinations thereof.

7. The polyurethane-based midsole composition as claimed in claim 1, wherein the hardener component further includes an aromatic diisocyanate polymer, the aromatic diisocyanate polymer being selected from the group consisting of poly(m-xylylene diisocyanate) and poly(hydrogenated m-xylylene diisocyanate).

8. A shoe midsole, which is prepared by subjecting the polyurethane-based midsole composition as claimed in claim 1 to a polymerization reaction, followed by conducting a foaming process and a molding process in sequence.

9. The shoe midsole as claimed in claim 8, wherein the shoe midsole has a density ranging from 0.2 g/cm³ to 0.4 g/cm³.

10. The shoe midsole as claimed in claim 8, wherein the shoe midsole has a hardness ranging from 20 Shore C to 70 Shore C.
